(19) United States
(12) Patent Application Publication
(10) Pub. No.: US 2006/0245966 A1
(43) Pub. Date: Nov. 2, 2006

(54) Rotor pump

(76) Inventor: Xiaoying Yun, Beijing (CN)

Correspondence Address: Kenneth E. Horton;Kirton & McConkie, 60 East South Temple, Ste. 1800, Salt Lake City, UT, 84111, US

(21) Appl. No.: 10/545,285

(22) PCT Filed: Feb. 11, 2004
(86) PCT No.: PCT/CN04/00111

§ 371 Date: May 25, 2006

(30) Foreign Application Priority Data
Feb. 12, 2003 (CN) 03102542.0

(51) Int. Cl. F16N 13/20; F04C 2/00; F01C 1/02; F01C 1/063; F03C 4/00; F04C 18/00; F01C 19/02; F04C 27/00

(52) U.S. Cl. 418/54; 418/125

(57) ABSTRACT

The invention discloses a rotary pump, comprising: a cylinder block which comprises a cylinder block body, a front end cover and a rear end cover which are attached to a front end surface and a rear end surface of the cylinder block body respectively, said cylinder block body and the front and rear end covers defining an inner chamber; a cam rotor fitted in the inner chamber of the cylinder block, the portion of the cam rotor with a maximum radius coming into sliding contact with an inner wall of the cylinder block so as to form an axially extending sealing region; a shaft, said cam rotor being mounted on the shaft and being rotatable therewith; separating means for separating an axially extending sealed chamber into an induction chamber and an exhaustion chamber, said axially extending sealed chamber being formed between the outer circumferential surface of the cam rotor and the inner surface of the cylinder block; an inlet and an outlet provided on the two sides of the separating means and communicating with the induction chamber and the exhaustion chamber respectively, wherein said separating means comprises: a separator plate which is provided with a pivot shaft at an end opposite to the cam rotor, said cylinder block body being formed with an axially extending hole which opens to the inner chamber, said separator plate pivot shaft being fitted in the hole and being rotatably supported by the hole so that it can rotate in a predetermined range, the inner end of the separator plate abutting against the outer circumferential surface of the cam rotor and separating the sealed chamber into the induction chamber and the exhaustion chamber, said separator plate pivot shaft being disposed between the inner surfaces of the front and rear end covers; a biasing spring for biasing the separator plate to force the inner end of the separator plate to abut against the outer circumferential surface of the cam rotor, one end of the biasing spring acting on the separator plate pivot shaft and the other end of the biasing spring acting on the cylinder block body.

### FIELD OF THE INVENTION

The invention relates to an energy conversion device which converts mechanical energy into pressure energy, and particularly to a rotary pump.

### BACKGROUND OF THE INVENTION

The conventional rotary pumps have much more advantages than pumps of other type, but they have the following drawbacks: the manufacturing process is complicated, the sealing is not reliable, and the reliability of the mechanical structure and the sealing drops deeply especially when the volume increases, and as a result, it is difficult to increase volume flow. The main reason that results in the above drawbacks lies in that the movable separating block, which separates the high pressure chamber from the low pressure chamber, has a small moving range and has a poor reliability. And when increasing the volume flow, the manufacturing process is more difficult to realized.

A pump is known in which a separator plate is mounted on a separator plate shaft or is integral with it, the separator plate shaft extends through and is supported by the front and rear end covers, and the biasing spring, which is located outside the end covers and biases the separator plate, acts on the portion of the separator plate shaft which extends out of the end covers. The pump with such structure has the following drawbacks: since the separator plate shaft is supported by the hole in the body of the cylinder block and the holes in the front and rear end covers, the requirements for the accuracy of the size of the three holes are high and the three holes must be strictly aligned; if the front and rear end covers displace relative to the cylinder block body due to vibration during the operation of the pump, or assembly errors exist, the three holes will not be aligned strictly. As a result, the rotation of the separator plate shaft will be affected, and thus the performance of the pump. Furthermore, the assembly process is very complicated.

### SUMMARY OF THE INVENTION

In consideration of the above, the object of the invention is to provide a rotary pump in which a more reliable sealing can be achieved between the high pressure chamber and the low pressure chamber, and the volume flow can be increased under the conditions of the same volume and weight. The rotary pump of the invention has a simple and compact structure, is easy to assemble and has an improved performance.

To achieve the above object, according to one aspect of the invention there is provided a rotary pump, comprising:

a cylinder block which comprises a cylinder block body, a front end cover and a rear end cover which are attached to a front end surface and a rear end surface of the cylinder block body respectively, said cylinder block body and the front and rear end covers defining an inner chamber;

a cam rotor fitted in the inner chamber of the cylinder block, the portion of the cam rotor with a maximum radius coming into sliding contact with an inner wall of the cylinder block so as to form an axially extending sealing region;

a shaft, said cam rotor being mounted on the shaft and being rotatable therewith;

separating means for separating an axially extending sealed chamber into an induction chamber and an exhaustion chamber, said axially extending sealed chamber being formed between the outer circumferential surface of the cam rotor and the inner surface of the cylinder block;

an inlet and an outlet provided on the two sides of the separating means and communicating with the induction chamber and the exhaustion chamber respectively, wherein said separating means comprises:
a separator plate which is provided with a pivot shaft at an end opposite to the cam rotor, said cylinder block body being formed with an axially extending hole which opens to the inner chamber, said separator plate pivot shaft being fitted in the hole and being rotatably supported by the hole so that it can rotate in a predetermined range, the inner end of the separator plate abutting against the outer circumferential surface of the cam rotor and separating the sealed chamber into the induction chamber and the exhaustion chamber, said separator plate pivot shaft being disposed between the inner surfaces of the front and rear end covers;
a biasing spring for biasing the separator plate to force the inner end of the separator plate to abut against the outer circumferential surface of the cam rotor, one end of the biasing spring acting on the separator plate pivot shaft and the other end of the biasing spring acting on the cylinder block body.

Preferably, said biasing spring is fitted in an axial hole formed on the separator plate pivot shaft.

Preferably, said axial hole is a through hole, and the pump comprises two biasing springs which are provided which are respectively disposed at the two ends of the through hole.

Preferably, said separator plate pivot shaft is formed with an axial blind hole on either axial end thereof, and a biasing spring is fitted in each of the blind holes.

Preferably, said biasing spring is a cylindrical torsional spring, a plate spring or a planar spiral spring.

Preferably, an axially extending slit is formed in the circumferential wall of the axial hole on the separator plate pivot shaft, and a circumferentially extending cutout is formed at the end of the circumferential wall of the axial hole which is adjacent to the end cover; and a radial recess is formed at the corresponding axial end of the hole in the cylinder block body, the radial recess is open at the axial end surface of the cylinder block body, one end of the biasing spring is disposed in the slit on the separator plate pivot shaft, and the other end of the spring extends out radially through the cutout on the separator plate pivot shaft and is disposed in the radial recess in the cylinder block body.

Preferably, the circumferential location of the cutout on the separator plate pivot shaft and thus the recess in the cylinder block body is on the side where the low pressure chamber is located.

Preferably, said cam rotor is a cylindrical cam rotor which comprises a cylindrical cam and a bush which ratatably fits over the cylindrical cam.

Preferably, said cam is formed with a weight-removing hole so as to reduce the centrifugal force generated when the cam rotor rotates.

Preferably, a receiving recess is formed in the inner wall of the cylinder block body, so that the separator plate is received in the receiving recess when pivoting to the upper position due to the rotation of the cam rotor.

Preferably, the side of the separator plate, which faces the cam rotor, is in the shape of a circular arc surface the radius of which is substantially equal to the radius of the inner chamber of the cylinder block, so that when the separator plate is in a position where it is received in the receiving recess, its contour is substantially flush with the contour of the inner chamber of the cylinder block.

According to another aspect of the invention, the rotary pump may include a plurality of cylinders. And in the rotary pump with a plurality of cylinders, the rotors are so arranged as to achieve dynamic balance.

With the separating means of the invention, the volume efficiency of the rotary pump is increased greatly, and the rotary pump has a simple structure and achieves rational conditions for mechanical movement, the noise and vibration can be further reduced and the operation performance of the pump is improved.

### BRIEF DESCRIPTION OF THE ACCOMPANYING DRAWINGS

The invention will be described in detail with reference to the accompanying drawings, in which

FIG. 1 is a cross-sectional view of the first embodiment of the rotary pump in accordance with the invention;

FIG. 2 is a longitudinal sectional view of the rotary pump shown in FIG. 1;

FIG. 3 is a schematic partial view of the pivot shaft of the separator plate, showing the axially extending slit and the circumferentially extending cutout formed on the circumferential wall of the sprint-mounting hole which is formed on the pivot shaft of the separator plate.

### DETAILED DESCRIPTION OF THE PREFERRED EMBODIMENTS

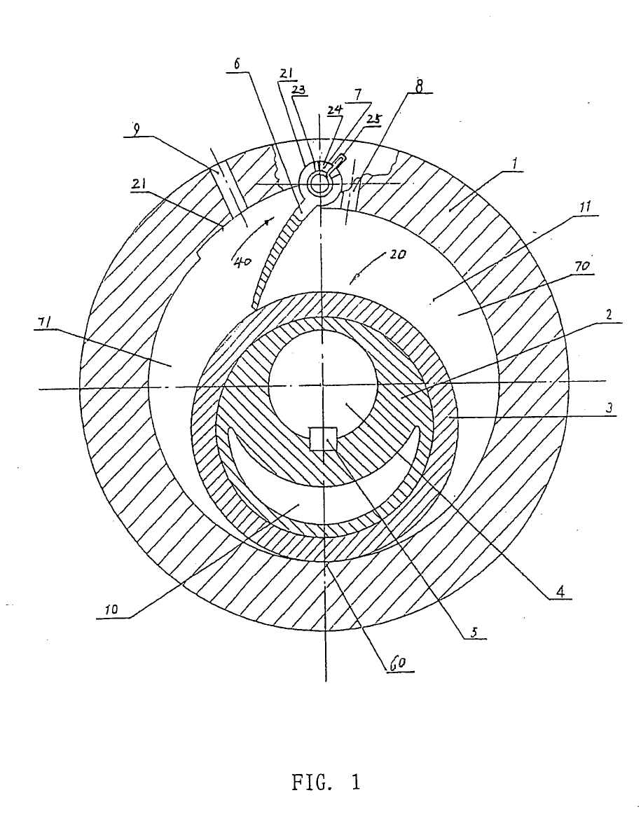

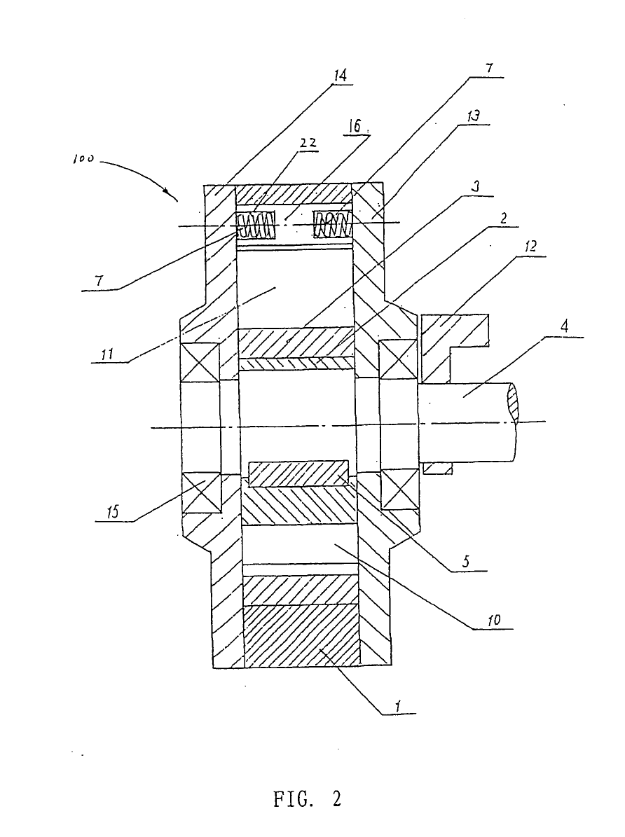

Reference is now made to FIGS. 1 and 2 which are the cross-sectional view and the longitudinal sectional view of a preferred embodiment of the rotary pump in accordance with the invention.

As shown in FIGS. 1 and 2, the rotary pump in accordance with the preferred embodiment of the invention comprises a cylinder block 100, the cylinder block 100 is comprised of a cylindrical cylinder block body 1, a front end cover 13 and a rear end cover 14, the front end cover 13 is attached to the front end surface of the cylinder block body 1 and the rear end cover 14 is attached to the rear end surface of the cylinder block body 1. The cylinder block body 1 and the front and rear end covers 13 and 14 define an inner chamber.

In the inner chamber of the cylinder block there is disposed a cam rotor 20, and an axially extending sealed chamber 11 is formed between the outer circumferential surface of the cam rotor and the inner surface of the cylinder block. The cam rotor 20 is mounted on a shaft 4 and is circumferentially fixed by means of a key 5. The shaft 4 is supported by the bearings 15 which are respectively mounted in the front and rear end covers 13 and 14. The cam rotor 20 has a contact portion 60 the radius of which is substantially equal to the radius of the inner chamber of the cylinder block, a clearance formed between the contact portion and the inner wall surface of the cylinder block is such that it allows the cam rotor to slide relative to the inner wall surface of the cylinder block and an axially extending sealing region is formed therebetween.

A separating means 40, which separates the sealed chamber 11 into an induction chamber 70 and an exhaustion chamber 71, is provided in the cylinder block 100. On the two sides of the separating means 40, there are respectively provided an inlet 8 and an outlet 9 in the wall of the cylindrical body which communicates with the induction chamber and the exhaustion chamber respectively.

As shown in FIGS. 1 and 2, the cam rotor 20 comprises a cylindrical cam 2 which is eccentrically mounted on the shaft 4 through a key 5, and a bush 3 is rotatably fitted over the cylindrical cam 2. To reduce the influence of the centrifugal force generated when the cam rotor 20 rotates, a weight-removing hole 10 is formed in the cylindrical cam. As an alternative solution of reducing the influence of the centrifugal force, a balance weight 12 may be mounted on the shaft 4. The above two solutions of reducing the influence of the centrifugal force may be used separately or used in combination. Since the bush 3 is rotatably fitted over the cylindrical cam 2, the bush 3 can rotate relative to the cylindrical cam 2 when the cam rotor 2 rotates, thus reducing the wear of the cam rotor 20 and/or the wall surface of the inner chamber of the cylinder block.

The separating means 40 comprises a separator plate 6 which is pivotally mounted on the cylindrical cylinder block body 1, and a biasing means is provided to force the inner end of the separator plate 6 to abuts against the outer circumferential surface of the cam rotor 20, and a sliding and sealing contact is achieved between the outer circumferential surface of the cam rotor and the inner end of the separator plate so as to separate the sealed chamber 11 into an induction chamber and an exhaustion chamber.

As a preferred solution, a receiving recess 21 may be formed in the inner wall of the cylinder block body 1, so that the separator plate 6 is received in the receiving recess when pivoting to the upper position due to the rotation of the cam rotor 20, thus improving the volume efficiency of the rotary pump while preventing the separator plate 6 from interfering with the rotation of the cam rotor 20. Preferably, the side of the separator plate 6, which faces the cam rotor 20, is in the shape of a circular arc surface the radius of which is substantially equal to the radius of the inner chamber of the cylinder block. Thus, when the separator plate 6 is in a position where it is received in the receiving recess 21, its contour is substantially flush with the contour of the inner chamber of the cylinder block.

The separator plate 6 is provided with a pivot shaft 16 at its distal end opposite to the cam rotor 20, and the pivot shaft 16 is fitted in a hole 21 which is formed in the cylinder block body 1 and extends axially, the hole 21 opens to the inner chamber of the cylinder block at its radial inner side. The pivot shaft 16 is mounted in the hole 21 and thus is rotataly supported by the hole 21. The pivot shaft 16 is disposed between the inner end surfaces of the front and rear end covers with a necessary axial fit clearance between the shaft 16 and the inner end surfaces of the front and rear end covers, and thus the pivot shaft 16 is not associated with the covers in any other way.

The biasing means of the separating means 40 comprises a cylindrical helical spring 7. As shown, the biasing spring 7 is fitted in the axial hole 22 formed in the shaft 16, one end of the biasing spring 7 acts on the shaft 16 and the other end acts on the stator so as to bias the separator plate 6 to force the inner end of the separator plate 6 to abut against the outer circumferential surface of the cam rotor 20. Similarly, the biasing spring 7 is not associated with the end covers in any way.

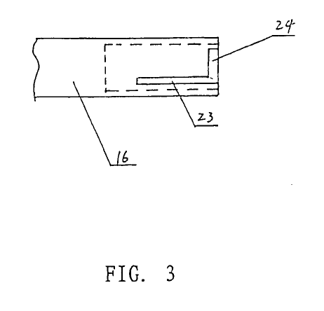

In the shown embodiment, the shaft 16 is formed with a spring-mounting hole 22 on either axial side of the shaft 16. In order to mount the biasing spring 7, an axially extending slit 23 is formed in the circumferential wall of the spring-mounting hole 22 of the shaft 16, and a shallow circumferentially extending cutout 24 is formed at the end of the circumferential wall of the spring-mounting hole 22 which is adjacent to the end cover; and furthermore, a radial recess 25 is formed at the axial end of the hole 21 of the cylinder block body 1, the radial recess 25 is axially open at the axial end face of the cylinder block body 1, as shown in FIGS. 1 and 3.

Accordingly, when mounting the biasing spring 7, one end of the cylindrical helical spring is inserted into the slit 23 of the shaft 16. Therefore, the one end of the torsional spring is located in the slit 23 when the main body of the torsional spring is inserted into the spring-mounting hole 22. And the other end of the spring extends out radially through the cutout 24 formed on the shaft 16 and is inserted into the radial recess 25 in the cylinder block body 1, thus fitting the biasing sprint in place. Since the other end of the spring extends out radially through the cutout 24 formed on the shaft 16 and is inserted into the radial recess 25 in the cylinder block body 1, it can be located inside the axial end surface of the cylinder block body 1. The circumferential size of the cutout 24 on the shaft 16 is such that it does not impede the rotation of the pivot shaft 16 of the separator plate. Preferably, in the assembled state, the circumferential location of the cutout 24 on the shaft 16 and thus the location of the recess 25 in the cylinder block body 1 are at the side where the low pressure chamber is located.

As compared with the prior art solution in which the shaft of the separator plate extends out through the end covers and the biasing spring is located outside the end cover, the rotary pump of the present invention leads to improvements of the assembly process and is simple and compact in structure, because the pivot shaft 16 of the separator plate is not associated with the end covers in any other way except that a necessary axial fit clearance is maintained between it and the inner end surfaces of the front and rear end covers of the cylinder block and the biasing spring is not associated with the front and rear end covers of the cylinder block in any way.

The operation of the rotary pump in accordance with the invention is now described in connection with the drawings.

As shown in FIG. 1, when the cam rotor 2, which is driven by the shaft 4, rotates clockwise in the direction indicated by the arrow, the volume of the induction chamber 70 increases, and therefore a negative pressure is established in the induction chamber. As a result, gas or liquid flows into the cylinder via the inlet 8 which communicates with the induction chamber; at the same time, the gas or liquid in the exhaustion chamber 71 is compressed as the contact portion 60 rotates clockwise, and is discharged via the outlet 9 which communicates with the exhaustion chamber. Under the action of the biasing means, the separator plate is kept in good contact with the rotor all the time. Therefore, a good sealing is achieved between the induction chamber and the exhaustion chamber to allow for the above-mentioned operation. The above process is repeated continuously as the cam rotor rotates.

Although the invention has been described in connection with the embodiments, those skilled in the art will appreciate that the embodiments are exemplary but not limitative, various modifications are possible without departing from the spirit and scope of the invention.

As an alternative to the above solution, a structure as described below can be adopted. An axially extending plate spring, which is integral with the pivot shaft of the separator plate, may be provided on the side of the separator plate pivot shaft opposite to the separator plate, and an axially extending slot may be formed in the wall of the hole 21 in the cylinder block body 1. In the assembled state, the plate spring is inserted axially into the axially extending slot in the cylinder block body 1, thus the other end of the separator plate abuts against the outer circumferential surface of the cam rotor under the action of the plate spring.

Furthermore, in the above embodiment, a spring-mounting hole 22 is formed on each axial end of the separator plate pivot shaft 16 and a biasing spring is fitted in each spring-mounting hole. As an alternative, however, it is possible that only one axial end of the separator plate pivot shaft 16 is formed with a spring-mounting hole into which a biasing spring is fitted. Moreover, in the above two solutions, the spring-mounting hole(s) may be through hole(s). In the above embodiment, one end of the biasing spring, which is opposite to the end cover, is disposed in the axially extending slit 23 formed in the circumferential wall of the spring-mounting hole 22, this can be modified such that the one end of the biasing spring, with its structure modified, is disposed in a slot formed on the bottom of the spring-mounting hole 22.

In the above embodiment, a cylindrical torsional spring is used. However, the cylindrical torsional spring may be replaced by a plate spring, which is in the shape of Ω when viewing in the axial direction or a planar spiral spring. When Ω type plate spring is used, one end of the plate spring is disposed the slit 23, and the other end of the plate spring extends out radially through the cutout 24 formed on the shaft 16 and is inserted into the radial recess 25 in the cylinder block body 1. And when a planar spiral spring is used, the radial inner end of the spring needs to extend out through the coils of the planar spiral spring, therefore a hole should be formed on each coil. Thus, the two ends of the planar spiral spring may be inserted respectively into the slit 23 and the radial recess 25 in the cylinder block body 1.

In the above embodiment, the inlet 8 and the outlet 9 are respectively formed in the circumferential wall of the cylinder block body 1, however they can also be formed in the front and rear end covers. In addition, a plurality of separating means may be provided in the circumferential direction of the cylinder block body.

1-17. (canceled)

18. A rotary pump, comprising:
a cylinder block containing a cylinder block body with a front end cover and a rear end cover defining an inner chamber, the cylinder block body formed with a hole opening to the inner chamber;
a cam rotor located within the inner chamber and being mounted on a shaft and rotating thereon, wherein a sealed chamber is formed between an outer surface of the cam rotor and an inner surface of the cylinder block; and
means for separating the inner chamber into an induction chamber and an exhaustion chamber, the separating means containing:
an inlet for communicating with the induction chamber;
an outlet for communicating with the exhaustion chamber;
a separator plate comprising a pivot shaft at an end opposite the cam rotor, the pivot shaft being disposed between the front and rear end covers and located in the hole of the cylinder block body and rotating within the hole; and
a spring for biasing the separator plate to force an inner end of the separator plate against an outer surface of the cam rotor, wherein a first end of the biasing spring acts on the pivot shaft and a second end acts on the cylinder block body.

19. The rotary pump of claim 18, wherein the biasing spring is fitted in an axial hole on the pivot shaft of the separator plate.

20. The rotary pump of claim 19, wherein said axial hole is a blind hole.

21. The rotary pump of claim 20, wherein the pivot shaft contains a blind hole on an axial end and a biasing spring is fitted in the blind hole.

22. The rotary pump of claim 19, wherein said axial hole is a through hole.

23. The rotary pump of claim 22, wherein two biasing springs are disposed at the two ends of the through hole.

24. The rotary pump of claim 19, wherein said biasing spring comprises a cylindrical torsional spring, a plate spring, or a planar spiral spring.

25. The rotary pump of claim 18, wherein the inlet and outlet are formed on the cylinder block body or the front and rear end covers.

26. The rotary pump of claim 18, wherein the cam rotor comprises a cylindrical cam and a bush rotatably fitted thereon.

27. The rotary pump of claim 18, wherein said cam contains a weight-removing hole to reduce the centrifugal force generated when the cam rotor rotates or a balance weight attached to the shaft to balance the centrifugal force.

28. The rotary pump of claim 18, further comprising a recess in the inner wall of the cylinder block body that receives the separator plate when that cam rotor rotates.

29. The rotary pump of claim 28, wherein a side of the separator plate facing the cam rotor comprises an arc-shaped surface with the arc radius being substantially equal to the radius of the inner chamber of the cylinder block.

30. A system for converting mechanical energy to pressure energy, the system containing a rotary pump comprising:
a cylinder block containing a cylinder block body with a front end cover and a rear end cover defining an inner chamber, the cylinder block body formed with a hole opening to the inner chamber;
a cam rotor located within the inner chamber and being mounted on a shaft and rotating thereon, wherein a sealed chamber is formed between an outer surface of the cam rotor and an inner surface of the cylinder block; and
means for separating the inner chamber into an induction chamber and an exhaustion chamber, the separating means containing:
an inlet for communicating with the induction chamber;
an outlet for communicating with the exhaustion chamber;
a separator plate comprising a pivot shaft at an end opposite the cam rotor, the pivot shaft being disposed between the front and rear end covers and located in the hole of the cylinder block body and rotating within the hole; and
a spring for biasing the separator plate to force an inner end of the separator plate against an outer surface of the cam rotor, wherein a first end of the biasing spring acts on the pivot shaft and a second end acts on the cylinder block body.

31. A rotary pump, comprising:
a cylinder block containing a cylinder block body with a front end cover and a rear end cover defining an inner chamber, the cylinder block body formed with a hole opening to the inner chamber;
a cam rotor located within the inner chamber and being mounted on a shaft and rotating thereon, wherein a sealed chamber is formed between an outer surface of the cam rotor and an inner surface of the cylinder block; and
means for separating the inner chamber into an induction chamber and an exhaustion chamber, the separating means containing:
means for communicating with the induction chamber;
means for communicating with the exhaustion chamber;
means for pivoting the separating means; and
means for biasing the pivoting means to force the separating means against an outer surface of the cam rotor, a portion of the biasing means acting on the pivoting means and another portion of the biasing means acting on the cylinder block body.

32. A method of making a rotary pump, the method comprising:
providing a cylinder block containing a cylinder block body with a front end cover and a rear end cover defining an inner chamber, the cylinder block body formed with a hole opening to the inner chamber;
providing a cam rotor located within the inner chamber and being mounted on a shaft and rotating thereon, wherein a sealed chamber is formed between an outer surface of the cam rotor and an inner surface of the cylinder block; and
providing means for separating the inner chamber into an induction chamber and an exhaustion chamber, the separating means containing:
an inlet for communicating with the induction chamber;
an outlet for communicating with the exhaustion chamber;
a separator plate comprising a pivot shaft at an end opposite the cam rotor, the pivot shaft being disposed between the front and rear end covers and located in the hole of the cylinder block body and rotating within the hole; and
a spring for biasing the separator plate to force an inner end of the separator plate against an outer surface of the cam rotor, wherein a first end of the biasing spring acts on the pivot shaft and a second end acts on the cylinder block body.

33. A method of making a rotary pump, the method comprising:
providing a cylinder block containing a cylinder block body with a front end cover and a rear end cover defining an inner chamber, the cylinder block body formed with a hole opening to the inner chamber;
providing a cam rotor located within the inner chamber and being mounted on a shaft and rotating thereon, wherein a sealed chamber is formed between an outer surface of the cam rotor and an inner surface of the cylinder block; and
providing means for separating the inner chamber into an induction chamber and an exhaustion chamber, the separating means containing:
an inlet for communicating with the induction chamber;
an outlet for communicating with the exhaustion chamber;
a separator plate comprising a pivot shaft at an end opposite the cam rotor, the pivot shaft being disposed between the front and rear end covers and located in the hole of the cylinder block body and rotating within the hole; and
a spring for biasing the separator plate to force an inner end of the separator plate against an outer surface of the cam rotor, wherein a first end of the biasing spring acts on the pivot shaft and a second end acts on the cylinder block body.

34. A method for converting mechanical energy to pressure energy, the method comprising:
providing a rotary pump comprising:
a cylinder block containing a cylinder block body with a front end cover and a rear end cover defining an inner chamber, the cylinder block body formed with a hole opening to the inner chamber;
a cam rotor located within the inner chamber and being mounted on a shaft and rotating thereon, wherein a sealed chamber is formed between an outer surface of the cam rotor and an inner surface of the cylinder block; and
means for separating the inner chamber into an induction chamber and an exhaustion chamber, the separating means containing:
an inlet for communicating with the induction chamber;
an outlet for communicating with the exhaustion chamber;
separator plate comprising a pivot shaft at an end opposite the cam rotor, the pivot shaft being disposed between the front and rear end covers and located in the hole of the cylinder block body and rotating within the hole; and
spring for biasing the separator plate to force an inner end of the separator plate against an outer surface of the cam rotor, wherein a first end of the biasing spring acts on the pivot shaft and a second end acts on the cylinder block body; and
exerting a mechanical force on the rotary pump.
